(19) United States
(12) Patent Application Publication
(10) Pub. No.: US 2025/0223177 A1
(43) Pub. Date: Jul. 10, 2025

(54) Delamination Of Halogen And Chalcogen Terminated MXenes

(71) Applicant: Drexel University, Philadelphia, PA (US)

(72) Inventors: Yury Gogotsi, Ivyland, PA (US); Teng Zhang, Philadelphia, PA (US)

(21) Appl. No.: 19/016,006

(22) Filed: Jan. 10, 2025

Related U.S. Application Data
(60) Provisional application No. 63/619,680, filed on Jan. 10, 2024.

(51) Int. Cl. C01B 32/921

(52) U.S. Cl. CPC C01B 32/921; C01P 2006/80

(57) ABSTRACT

A method, comprising: contacting a multilayered MXene comprising at least one of halogen or chalcogen terminations with cations dissolved in a non-aqueous solvent so as to give rise to a cation-intercalated MXene; and delaminating the cation-intercalated MXene. A MXene layer, the MXene layer comprising uniform or essentially uniform terminations. A method, comprising: delaminating a cation-intercalated MXene comprising at least one of halogen or chalcogen terminations so as to give rise to a MXene layer comprising uniform or essentially uniform terminations.

### CROSS-REFERENCE TO RELATED APPLICATIONS

This application claims priority to and the benefit of U.S. Provisional Application No. 63/619,680, “Delamination Of Halogen And Chalcogen Terminated MXenes,” filed Jan. 10, 2024. All foregoing applications are incorporated herein by reference in their entireties for any and all purposes.

### GOVERNMENT RIGHTS

This invention was made with government support under Contract No. DE-SC0018618 awarded by the Department of Energy. The government has certain rights in the invention.

### TECHNICAL FIELD

The present disclosure relates to the field of materials science, in particular to the field of MXene materials.

### BACKGROUND

MXenes produced by Lewis acid molten salt (LAMS) etching of MAX phases have attracted the community's attention due to their controllable surface chemistry. However, their delamination is challenging due to the hydrophobicity of the produced multilayer MXene and strong interactions between the halogen-terminated MXene sheets. The current delamination method involves dangerous chemicals such as n-butyllithium or sodium hydride, making scale-up difficult and limiting the practical application of this class of MXenes. Accordingly, there is a long-felt need in the art for improved MXene delamination methods.

### SUMMARY

In this work, we present a simple and efficient method for the delamination of MXenes from LAMS synthesis while maintaining their surface chemistry. LiCl salt and anhydrous polar organic solvents are used for delamination. Films produced from the delaminated MXene were flexible and had an electrical conductivity of 8,000 S/cm, which maintains the value after a week of exposure to 95% humidity. This successful delamination, preservation of inherent surface properties, and stability under high-humidity conditions dramatically expand the range of MXene chemistries available for research and potential applications.

In one aspect, the present disclosure provides a method, comprising: contacting a multilayered MXene comprising at least one of halogen or chalcogen terminations with cations dissolved in a non-aqueous solvent so as to give rise to a cation-intercalated MXene; and delaminating the cation-intercalated MXene.

Also provided is a MXene layer, the MXene layer comprising uniform or essentially uniform terminations. The MXene layer can be present as a single layer and not as part of a multilayered MXene stack.

Further provided is a method, comprising: delaminating a cation-intercalated MXene comprising at least one of halogen or chalcogen terminations so as to give rise to a MXene layer comprising uniform or essentially uniform terminations. The MXene layer can be present as a single layer and not as part of a multilayered MXene stack.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1B. Illustration of (FIG. 1A) Lewis acid molten salt (LAMS) synthesis of uniformly terminated MXene and (FIG. 1B) its delamination process. The delamination is performed under argon.

FIGS. 2A-2G. Characterization of LAMS-Ti₃C₂Cl₂ MXene. (FIG. 2A) X-ray diffraction patterns of LAMS-Ti₃C₂Cl₂ as the pristine multilayer powder (black), LiCl intercalated multilayer powder (brown), LiCl delaminated film (red) and n-butyllithium delaminated freestanding film (green). 2θ=4° to 45°. The d-spacing was calculated based on (002) peaks. Optical image of (FIG. 2B) LiCl delaminated LAMS-Ti₃C₂Cl₂ solution and (FIG. 2C) the vacuum-filtered freestanding film. (FIG. 2D) Scanning Electron Microscopy (SEM) and (FIG. 2E) Transmission Electron Microscopy (TEM) images of single-layer Ti₃C₂Cl₂ flakes delaminated with LiCl. (FIG. 2F, 2G) SEM images showing the surface morphology of LiCl delaminated LAMS-Ti₃C₂Cl₂ freestanding film at different magnifications.

FIGS. 3A-3F. (FIG. 3A-3D) XPS spectra of LiCl delaminated LAMS-Ti₃C₂Cl₂ freestanding film. (FIG. 3A) Survey scan and (FIG. 3B-3D) high-resolution XPS spectra of (FIG. 3B) Ti 2p, (FIG. 3C) C Is, and (FIG. 3D) Cl 2p of Ti₃C₂Cl₂ MXene freestanding film. (FIG. 3E) Raman spectra of LiCl delaminated LAMS-Ti₃C₂Cl₂ MXene on a gold substrate at different laser wavelengths. (FIG. 3F) Thermal gravimetric analysis of LiCl delaminated LAMS-Ti₃C₂Cl₂ MXene freestanding film.

FIGS. 4A-4C. (FIG. 4A) Digital photograph of Ti₃C₂Cl₂ MXene colloidal solution in NMF. (FIG. 4B) UV-Vis of Ti₃C₂Cl₂ MXene solution with different delamination agents and solvent, inset picture shows the Tyndall effect. (FIG. 4C) Spray-coated Ti₃C₂Cl₂ MXene on a glass substrate with different thicknesses.

FIGS. 5A-5C. (FIG. 5A) Digital photograph of Ti₃C₂Cl₂ MXene freestanding film from the top view. (FIG. 5B) Water contact angles of Ti₃C₂Cl₂ MXene freestanding film (top) and HF etched Ti₃C₂Tₓ freestanding film. (FIG. 5C) Change of four-point electrical resistance of a Ti₃C₂Cl₂ MXene freestanding film between 20% and 95% humidity at 35° C.

FIG. 6. Comparing of LMAS-Ti₃C₂Cl₂ MXene before (left) and after (right) NMF swelling. The volume expanded from ˜2 mL to ˜12 mL after swelling. Pictures were taken in the glove box.

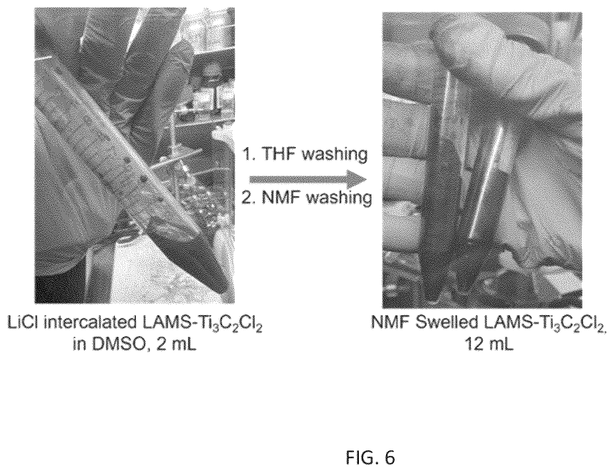

FIG. 7. A comprehensive flow chart of delaminating LAMS-MXene steps with different routines and failed routines are included. There are four routines tried here in step 2. Two routines failed delamination: step (2a). Direct wash with aprotic solvent: step (2b). Wash with THE first, followed by NMP/DMSO/DMF or PC. The other two routines gave successful delamination: step (2c). Toluene-NMF routine and step (2d). THF-NMF routine.

FIGS. 8A-8B. X-ray diffraction patterns of multilayer LAMS-Ti₃C₂Cl₂ MXene as different stages of washing corresponding to FIG. 13. (FIG. 8A), zoomed in the XRD pattern from 5 to 18 degrees to show low angle (002) peaks and (FIG. 8B) scan from 2 degree to 50 degree. All samples were mixed with Si powder for calibration except the pristine multilayer (black). The d-spacing was calculated based on 002 peaks.

FIG. 9. Optical photo of LiCl delaminated LAMS-Ti₃C₂Cl₂ MXene solutions stored on the shelf for three months. The aggregation was not observed.

FIG. 10. Colloidal Stability test of delaminated LAMS-MXene in different solvents. From left to right: DI Water, Acetone, Methanol, Ethanol, iso-propanol, Acetonitrile, N-Methylpyrrolidone, N, N-Dimethylformamide, Dimethyl Sulfoxide and Propylene Carbonate.

FIG. 11. Close view photo of delaminated LAMS-MXene in Acetonitrile with solvent exchange after 3 days (left) and 5 days (right) Even though it's shown a black color and stable colloidal stability in far view, the close view under light shows the heavy aggregation after 3 days. After 5 days of storage, the dark brown color supernatant and complete precipitation showed a potential degradation of MXene, which may indicate the inherent chemical and colloidal instability of LAMS-MXene in acetonitrile.

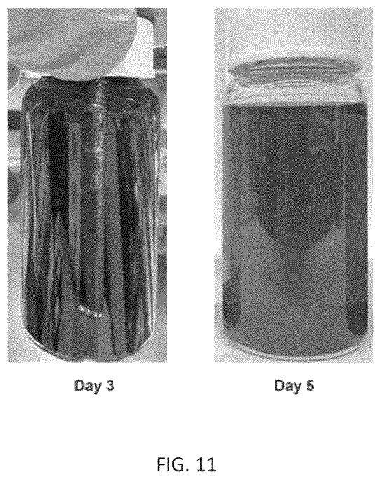

FIG. 12. X-ray diffraction patterns of Ti₃AlC₂ MAX phase and LAMS-Ti₃C₂Cl₂ MXene as the multilayer powder after HCl wash (blue), LiCl intercalated multilayer powder (brown), and LiCl delaminated film with NMF solvent (red), which were recorded from 4 to 70°. (002) and (004) peaks of the MAX phase shifted to a lower angle and the (104) peak of the MAX phase disappeared in multilayer powder, indicating the removal of the Al layer. No zinc diffraction peaks are observed.

FIGS. 13A-13B. SEM images of LiCl delaminated Ti₃C₂Cl₂ MXene. (FIG. 13A) A zoomed-out view of LiCl delaminated LMAS-Ti₃C₂Cl₂ MXene flakes (dark spots) on AAO support shows successful delamination. (FIG. 13B) Cross-sectional SEM image of a freestanding film showing stacked MXene layers.

FIGS. 14A-14F. XPS spectra of pristine multilayer LAMS-Ti₃C₂Cl₂ MXene. (FIG. 14A) Survey scan and (FIG. 14B-14F) High-resolution XPS spectra of (FIG. 14B) Ti 2p, (FIG. 14C) C Is, (FIG. 14D) Cl 2p, (FIG. 14E) O 1s and (FIG. 14F) Al 2p of Ti₃C₂Cl₂ MXene multilayer powder. All spectra were collected without Ar sputtering. The survey scan of multilayer Ti₃C₂Cl₂ MXene XPS spectra showed strong oxygen peaks and Al peaks, which come from Al₂O₃ residuals from MAX phases according to high-resolution XPS spectra of O 1s and Al 2p. In LAMS synthesis, unlike HF etching, which removes Al₂O₃ and Ti—O—Al compounds, Al₂O₃remains stable during etching and HCl washing. Ar sputtering would remove the Ti—O—Al complex and Al₂O₃ layers of multilayer LAMS MXene.

FIGS. 15A-15B. High-resolution XPS spectra of LiCl delaminated LAMS-Ti₃C₂Cl₂ MXene freestanding film showing (FIG. 15A) O 1s and (FIG. 15B) Al 2p regions. A low signal of O 1s with dominant C—O/C—O confirms that no oxidation occurred during the delamination of MXene. The Al 2p spectra show no Al residual in delaminated MXene films.

FIGS. 16A-16B. Characterization of LiCl delaminated LAMS-Ti₃C₂Cl₂ MXene freestanding film after heating in argon in TGA to 1300° C. (FIG. 16A) SEM image and (FIG. 16B) XRD pattern showing the transformation of MXene to nanocrystalline cubic TiC. Weak TiO₂ diffraction peaks observed after TGA measurement may come from the oxygen in the X-sublattice of MXene or NMF solvent or result from the cooling with compressed air after TGA measurement.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having.” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated #10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value: they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

MXenes, a family of two-dimensional (2D) transition metal carbides, carbonitrides, and nitrides, have emerged as versatile materials owing to their unique properties and wide range of potential applications. Since their discovery, the pursuit of effective, efficient, and benign methods for synthesizing and processing MXenes has remained an area of intensive research. MXenes are typically produced by selective etching of layered precursors, such as MAX phases (e.g., Ti₃AlC₂). Among the numerous MXene synthesis methods reported, wet chemical etching in fluorine-containing acids and Lewis acid molten salt (LAMS) etching are currently the only scalable ones. MXenes produced by those methods attract much attention. Acidic etching leads to O/OH terminated surfaces, eventually, with some —F or —Cl. These MXenes can be delaminated with an aqueous solution of salts into single-layer flakes for further research, but mixed and oxygen-containing terminations limit the surface chemistry control. LAMS synthesis produces MXenes with halogen terminations, offering distinctly different properties and a possibility for substitution with a variety of species and covalent bonding of molecules.¹³⁻¹⁶ Nevertheless, delaminating these materials presents significant challenges stemming from the inherent hydrophobic nature of the synthesized MXenes and the robust interlayer interactions among halogen-terminated MXene sheets. Presently, the delamination has a low yield, and the process relies on using hazardous chemicals, including n-butyllithium and sodium hydride (NaH). This complicates the scaling up of production and hinders the broader development and practical deployment of this category of MXenes. Multiple attempts to delaminate LAMS-MXenes using other methods led to multilayer lamellas rather than high-quality single-layer flakes.

To address these challenges, this study presents a safe and straightforward method for the delamination of MXenes synthesized via the LAMS method using LiCl—a benign, abundant, and inexpensive salt, as a delaminating agent. LiCl effectively delaminates MXenes and allows them to retain their surface chemistry, which was a challenging task. Moreover, using LiCl as a delaminating agent ensures the conservation of the intrinsic properties of Ti₃C₂Cl₂ MXene, specifically its electrical conductivity of 8,000 S/cm. Our results demonstrate that this property remains unaltered even under high humidity conditions, thereby suggesting enhanced environmental stability and widening the scope of MXene applications.

### Synthesis of Multilayer LAMS-MXene

Ti₃C₂Cl₂ MXene was synthesized by selective etching of the Al layers from Ti₃AlC₂ MAX phase precursor using a molten salt etchant with the following reactions:

$$2 {Ti}_{3} {AlC}_{2 ( s )} + 3 {ZnCl}_{2 ( l )} \to 2 {Ti}_{3} {C}_{2 ( s )} + 2 {AlCl}_{3 ( g )} + 3 {Zn}_{( s )} \qquad ( 1 )$$

$$2 {Ti}_{3} {C}_{2 ( s )} + 2 {ZnCl}_{2 ( l )} \to 2 {Ti}_{3} {C}_{2} {Cl}_{2 ( s )} + 2 {Zn}_{( s )} \qquad ( 2 )$$

During the reaction, Zn²⁺ is reduced to elemental Zn in the form of molten Zn flux surrounding the multilayer MXene particles, while Al is oxidized to AlCl₃ and evaporated as a gas at the reaction temperature of ˜660° C. Elemental Zn particle melt was majorly evaporated and deposited at the open end of the tube wall, which has a lower temperature. Since oxygen or water is not involved during the reaction, uniform —Cl termination is formed in the synthesized MXene. Once cooled to room temperature, the Zn melt solidified and became nanoparticles and flakes surrounding the multilayer MXene particles. The residual Zn metal in as-produced Ti₃C₂Cl₂ MXene was thoroughly washed away with 12 M HCl. Detailed procedures are shown in the experimental section.

### Intercalation of LAMS-MXene

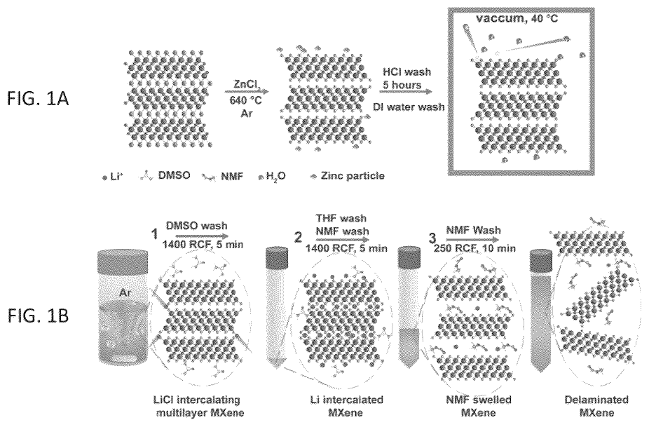

We determined that Cl-terminated MXene produced using the LAMS method (FIG. 1A) can be delaminated using Li salts in non-aqueous solvents, such as dimethyl sulfoxide (DMSO). Here, we use LiCl as an example (FIG. 1B). Since LAMS-MXene is hydrophobic, the hydrated cations are difficult to intercalate between MXene layers. Thus, the whole delamination process must be performed in a moisture-free environment to prevent the hydration shell formation of Li⁺. Here, the experiment was performed in an Ar-filled glove box. First, 1.2 g of LiCl was added to 10 mL DMSO (Sigma Aldrich, >99.9%, anhydrous) in a 20 mL glass vial and fully dissolved by stirring with a PTFE-coated magnetic stir bar for 10 minutes in a closed vial. Then, 3 g of multilayer LAMS-Ti₃C₂Cl₂ was added to the solution and stirred at 1,000 rpm for 24 hours for the intercalation. A vortex of MXene was observed.

### Swelling of LAMS-MXene

After the treatment with LiCl/DMSO, the Li intercalated multilayer LAMS-Ti₃C₂Cl₂ was transferred into a 15 mL centrifuge tube and centrifuged at 1,500 rcf for 5 minutes to remove the DMSO solvent and excess lithium chloride (LiCl, Thermal Scientific Chemicals, anhydrous, 99.0%) salt. To remove the LiCl salt further, 10 mL tetrahydrofuran (THF, Sigma Aldrich, anhydrous, >99.9%) was added to the tube and washed twice at 1,500 rcf for 5 minutes. After washing with THF and centrifugation, a small volume expansion of MXene sediment was observed compared to DMSO-drained sediment (before THE wash). After removing excess Li cations with THF, the sediment was redispersed into 2 vials of 15 mL N-methylformamide (NMF, Sigma Aldrich, ≥99.9%, anhydrous) for delamination. The heavy swelling was observed with one or two washes with a great volume expansion (˜ 2-3 times), and the MXene had a slurry-like morphology, similar to the delamination process of acid-etched MXene. Therefore, intense manual shaking is required to redisperse the swelled LAMS-MXene into NMF again at this and the following steps for a high yield of delamination. The dark brown supernatant with small multilayers and a few layers of LAMS-MXene was observed during the washing process and decanted into waste. Further washing with NMF resulted in swelling LAMS-MXene and expanding to ˜5 times its original volume, named NMF-swelled MXene (FIG. 1B, 6).

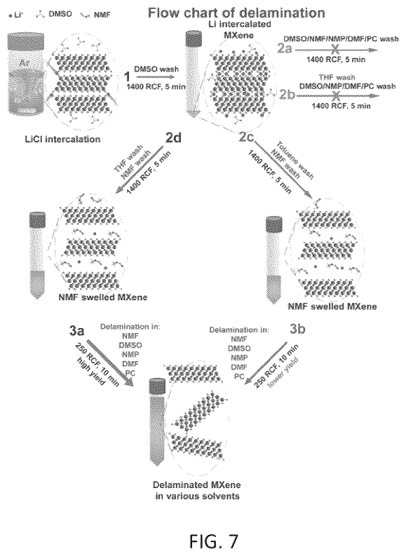

When NMF was replaced with N-dimethylformamide (DMF, Sigma-Aldrich, anhydrous, 99.8%), a solvent with similar structure and properties, the swelling of MXene was not observed after 7 washes based on the observation of volume change. One possible explanation could be a significant dielectric constant difference between the two solvents (182 for NMF vs. 36.7 for DMF). NMF with a high dielectric constant effectively screens the electrostatic interactions between negatively charged MXene layers and intercalated Li cations and provides better solvation of lithium cations. This weakens the interaction between the MXene layers and aids in the swelling of MXene. Attempts to swell MXene with other polar aprotic solvents including N-methylpyrrolidone (NMP, Sigma-Aldrich, anhydrous, 99.5%), acetonitrile (ACN, Sigma-Aldrich, anhydrous, 99.8%), dimethyl sulfoxide (DMSO, Sigma Aldrich, >99.9%, anhydrous), and propylene carbonate (PC, Sigma-Aldrich, anhydrous, 99.7%) were unsuccessful (FIG. 7).

### Delamination of LAMS-MXene in NMF

Continuous washing of NMF-swelled MXene with NMF will result in successful delamination by observing dark supernatant after centrifuging at 250 rcf for 5 minutes. This supernatant contained delaminated MXene with a large flake size and was collected. The collection process can be repeated multiple times. The MXene solutions were collected in a separate container for storage. After the supernatant became transparent, the LAMS-MXene sediment was collected and removed from the glovebox. Delamination of LAMS-MXene with n-butyllithium was performed. We also observed heavy swelling and volume expansion during the delamination process.

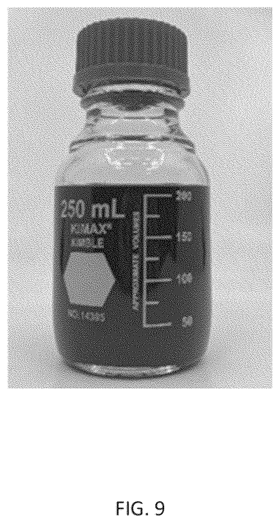

To increase the yield of delamination, bath sonication (Branson 2501 Ultrasonic Cleaner, 40 kHz) of residual LAMS-MXene-sediment in NMF was performed at room temperature for 20 minutes in a sealed centrifuge tube under Ar. Then, the collection of the MXene solution can be performed under an ambient environment without argon. The obtained solution was then concentrated by centrifugation at 11,200 rcf for 10 minutes and the supernatant was decanted to remove the small flakes of multilayer MXene. The sediment was redispersed with NMF to form a MXene colloidal solution. The MXene solution was stored in a glass bottle and remained stable without aggregation for more than 3 months (FIG. 9). The same delamination process was performed using another lithium salt, lithium bis(trifluoromethane) sulfonimide (LiTFSI, TCI, anhydrous, >98.0%). The LAMS-Ti₃C₂Cl₂ solution delaminated by LiTFSI was collected for UV-Vis measurement.

### Solvent Exchange of Delaminated MXene Solution and Freestanding Film Preparation

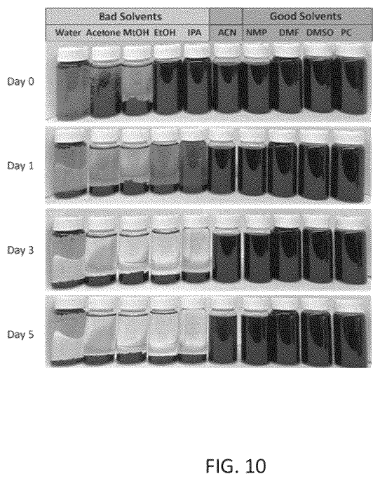

LiCl delaminated LAMS-MXene could be dispersed in other polar solvents, such as DMF, NMP, acetonitrile, DMSO, propylene carbonate and 2-propanol (IPA, Sigma-Aldrich, anhydrous, 99.5%) by solvent exchange under ambient atmosphere. Considering IPA as an example: NMF delaminated LAMS-Ti₃C₂Cl₂ solution was concentrated with a centrifuge at 11,200 rcf for 10 minutes. 10 mL concentrated MXene solution in NMF (˜6 mg/mL) was mixed with 30 mL IPA by manual shaking for 2 minutes and then centrifuged at 11,200 rcf for 10 minutes. The clear supernatant was removed and the MXene sediment was redispersed with an extra 40 mL IPA and repeated two times. The final sediments were redispersed into IPA and formed a colloidal solution. The solvent-exchange procedure was the same for all solvents tested. The colloidal solution stability of LAMS-MXene in protic IPA was much lower than in polar aprotic solvents such as NMF, DMF, NMP. DMSO, and PC, which were stable for more than 5 days and identified as “good solvents”. Sedimentation in IPA was observed after 24 hours of storage under ambient conditions (FIG. 10.) This may come from the low polarity or high hygroscopic nature of IPA, which absorbs water molecules from the ambient atmosphere.

Solvent exchange with other hydroscopic polar solvents with lower dipole moments, including acetone (ACS reagent, ≥99.5%), methanol (anhydrous, 99.8%), and ethanol (200 proof, ACS reagent, ≥99.5%) or with DI water failed to produce a colloidal solution. They were identified as “bad solvents” for LAMS-MXene (FIG. 10).

Freestanding films of MXene produced by different delamination methods were prepared via vacuum-assisted filtration through a 3501 Celgard membrane.

### Direct Delamination of NMF-Swelled MXene in Various Solvents

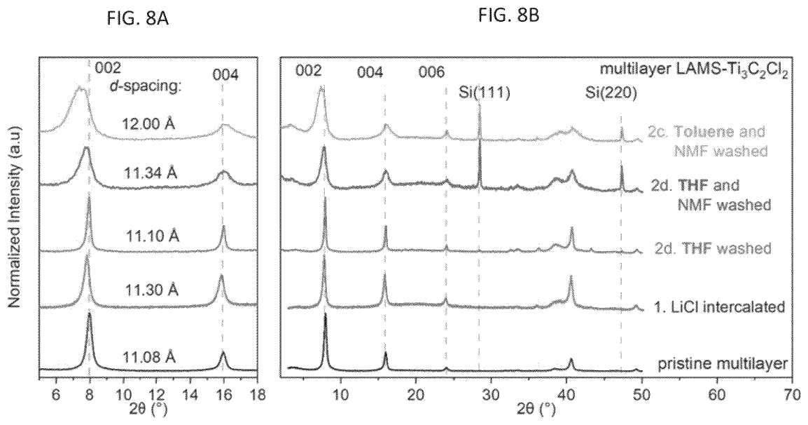

To address the toxicity concerns associated with NMF, we experimented with alternative, less toxic solvents. This experimentation is detailed in FIGS. 7 and 8A and 8B and the accompanying text, where we demonstrate that successful delamination is universally achievable with NMF-swelled MXene. Our experimental approach involved a two-step process: first, swelling the MXene in NMF, and then delamination it in a different, less toxic aprotic polar solvent. This method was tested with a range of solvents, including DMSO, DMF. NMP, acetonitrile, and PC. Those solvents were employed as the delaminating agents instead of NMF. The delamination protocol followed was similar to that previously described for NMF, as outlined in the section “Delamination of LAMS-MXene in NMF”. The key to this process was using bath sonication for 30 minutes. This technique enabled us to achieve delamination yields in these alternative solvents comparable to those obtained with NMF. It should be noted that while the procedure has been optimized for NMF, the optimal centrifuge speed and time might differ when using other solvents. Following delamination, the MXene solutions in various solvents were collected and stored in glass vials for further analysis and use. Other delamination routines are discussed in Supplementary Information.

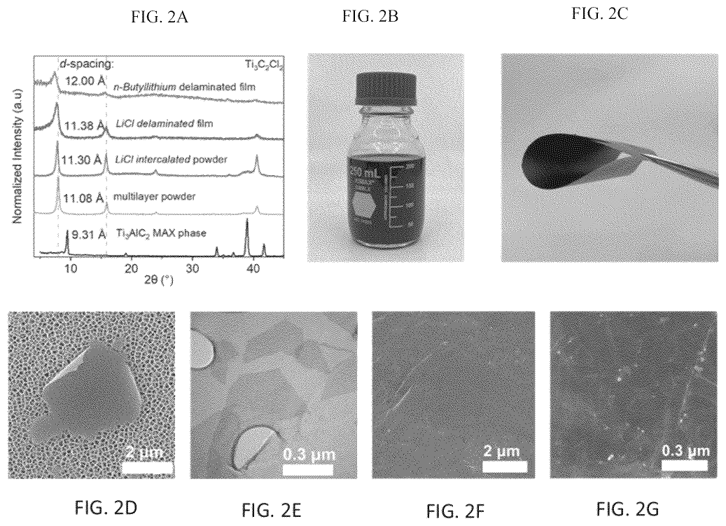

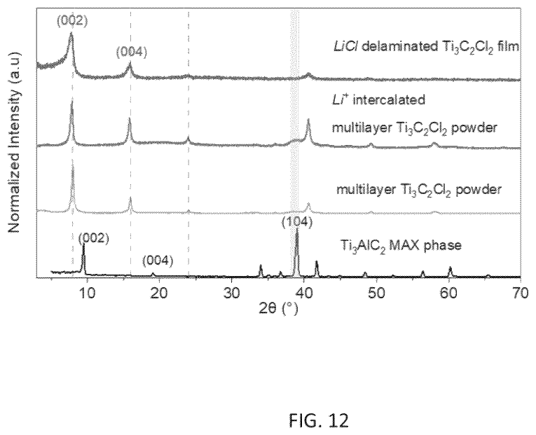

XRD patterns of the HCl-washed MAX phase and multilayer MXene powder are shown in FIG. 12. The elimination of (002), (004) and (104) peaks from the MAX phase confirms the complete conversion from MAX to MXene without zinc peaks in MXene powder, thus indicating the successful removal of zinc metal after the HCl wash. The XRD patterns of MXene powder and vacuum-filtrated freestanding MXene films are plotted in FIG. 2A. Based on the (002) peak position, the d-spacing of pristine Ti₃C₂Cl₂ MXene is 11.08 Å with a van der Waals (vdW) gap of ˜2.7 Å between MXenes. The d-spacing of n-butyllithium delaminated MXene expanded from 11.08 Å of pristine MXene powder to 12.00 Å, which is 0.79 Å larger than the reported n-butyllithium treated multilayer powder. Similarly, the d-spacing of LiCl intercalated MXene powder was 0.22 Å larger than that of pristine powder, and the corresponding delaminated film has an even greater d-spacing (11.38 Å). However, the XRD patterns do not obey Bragg's law. Theoretically, the increase of d-spacing at the (002) diffraction pattern is 2 times greater than the (004) diffraction pattern, and visually the (004) peak should shift farther than the (002) peaks. However, for all three samples, regardless of the intercalated powder or delaminated film, the inverse behavior in XRD patterns is observed: shifts of the (004) patterns are ˜½ less than the shift of the (002) patterns. This counterintuitive observation may come from the fact that MXenes are not typical crystals but rather stacks of flakes, which introduces variability in the d-spacing measurements. The uneven distribution of the layers stacking, flake misalignment, varying flake sizes, the coexistence of few-layered and single-layer MXene, and confined solvents between the layers result in an unsymmetric peak shape of the (002) peaks in FIG. 1A. This indicates that the (002) peak is inaccurate in determining the d-spacing. Therefore, the peak position of the (004) pattern was used to determine d-spacing for more accurate results.

Based on the (004) peak position, the d-spacing of pristine Ti₃C₂Cl₂ MXene is 11.08 Å with a van der Waals (vdW) gap of ˜2.7 Å between MXenes. After delamination with n-butyllithium, the d-spacing of MXene freestanding film is 11.36 Å, which is larger than n-butyllithium treated MXene powder (11.21 Å). The LiCl intercalated MXene powder and the LiCl delaminated freestanding film have d-spacings of 11.14 Å and 11.15 Å, respectively. The change of d-spacing from intercalated powder to delaminated freestanding films for LiCl MXene (0.01 Å) is much smaller than that of n-butyllithium MXene (0.28 Å). This can be explained by the difference in intercalants between the two samples: in n-butyllithium delaminated samples. Li⁺(NMF)ₓ solvents might be confined in MXene layers, whereas only Li⁺ ions were confined in LiCl delaminated MXene layers. One possible explanation could be the difference in intercalants between the two samples: in n-butyllithium delaminated samples, Li⁺(NMF)ₓ solvents may be confined in MXene layers, whereas only Li ions are confined in LiCl delaminated MXene layers. The LiCl delaminated film has a higher signal-to-noise ratio (SNR) compared to n-butyllithium delaminated freestanding film, indicating better flake alignment and more uniform stacking between MXene flakes with the LiCl delamination method. This may help explain the difference in conductivities: the electrical conductivity of n-butyllithium delaminated MXene is ˜2,100 S/cm, whereas the LiCl delaminated film has a conductivity up to 8,000 S/cm, which is comparable with the HF-etched MXene. It is worth noting that both the n-butyllithium and NaH were previously reported as highly reactive superbases, which may potentially influence the surface chemistry of MXenes, thus changing the d-spacing of delaminated MXene films.

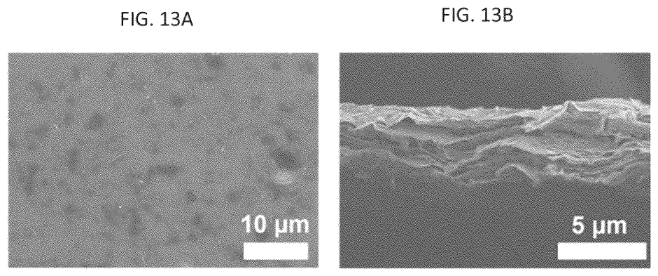

A digital photograph of the collected delaminated MXene solution is shown in FIG. 2B. The concentration of MXene can reach up to 30 mg/mL with the centrifugation process. The vacuum-filtered freestanding film is flexible, and the color is different from previously reported TMAOH delaminated LAMS-MXene (FIG. 2C). Compared to HF etched MXene, the LAMS-Ti₃C₂Cl₂ film is slightly more brittle than the HF-Ti₃C₂Tₓ film, which may be due to the lack of interlayer water and hydrogen bond network in the LAMS-Ti₃C₂Cl₂ film. The SEM image of single flakes shows LAMS-Ti₃C₂Cl₂ that scrolls up at the edge. This is prevalent in the delaminated flakes (FIGS. 2D, 13A). The TEM image in FIG. 2E shows the 2D flakes morphology of MXene, indicating successful delamination and separation of single-layer MXene. The cross-sectional SEM image of LiCl delaminatsed LAMS-Ti₃C₂Cl₂ freestanding film shows a layered stacked structure (FIG. 13B). The surface morphology of delaminated MXene freestanding film shows a smooth surface across the SEM image (FIG. 2F). Interestingly, the high-magnification SEM image shows the MXene flakes stacked underneath other flakes, which has not been observed in HF-etched MXene films. This may be due to the absence of confined water between LAMS-Ti₃C₂Cl₂ MXene layers and a weaker flake-flake interaction compared to MXenes made via the acid route (due to the absence of hydrogen bonding), resulting in fewer scattering events of secondary electrons across the restacked MXene layers.

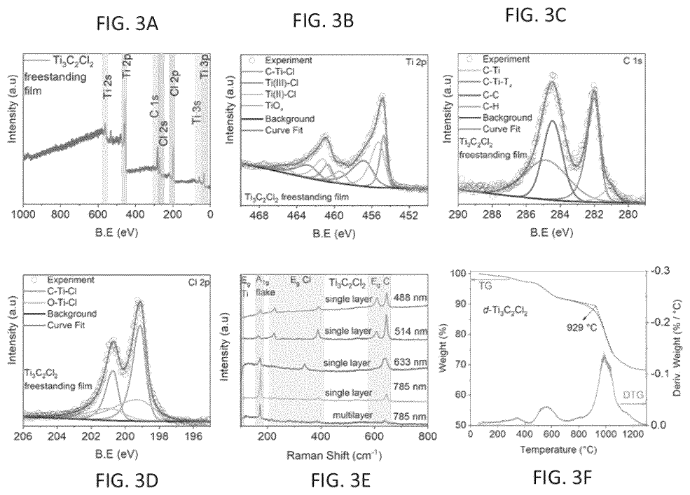

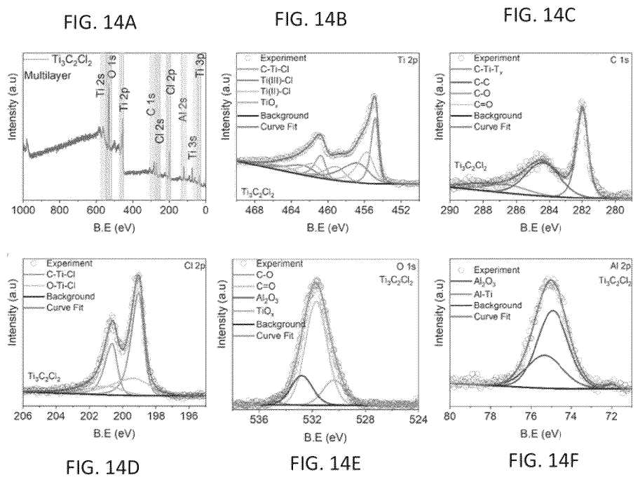

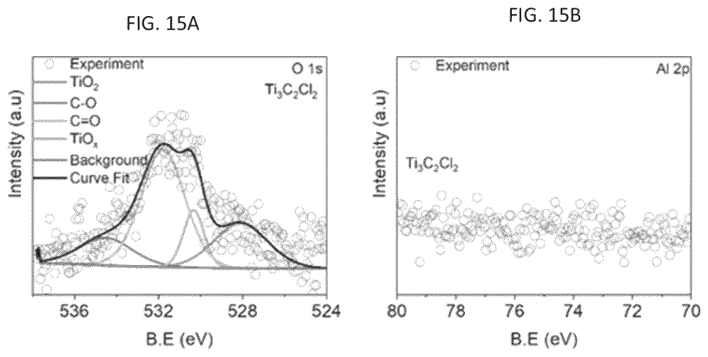

The quality of delaminated MXene was examined by the survey and core-level X-ray photoelectron spectra (XPS, FIG. 3A-3D, FIGS. 14A-14F). The XPS is done without any sputtering to show the actual quality of the MXene film. The survey scan of LiCl delaminated MXene freestanding film showed only Ti, C, and Cl peaks and a trivial amount of oxygen, indicating only Cl termination on the surface of the MXene flakes. By fitting the core-level Ti 2p XPS, the Ti—C component is at 454.7 eV, 455.2 eV, and 456.8 eV, and the trivial Ti—O component is at 459.3 eV which is attributed to the dissolved oxygen in the X lattice. Strong oxidization of Ti is not observed compared to previously reported delaminated MXene. The C Is spectra show that C—Ti and C—Ti—Cl components have binding energy at 281.1 eV and 282.0 eV. The existence of C—C and C—H components in C Is spectra comes from the residual NMF solvent and environment. Cl 2p XPS at 199.1 eV and 199.3 eV indicates all Cl are from termination, which bonded with Ti. The O 1s spectra are noisy with low intensity and majorly of the signal comes from C═O/C—O in NMF, indicating the low oxygen content in MXene after the delamination (FIGS. 15A-15B). In general, compared to previously reported delamination of molten salt MXene, this method shows the cleanest and highest quality in reserve their pristine chemistry to date.

Raman spectra of Ti₃C₂Cl₂ MXene provide a comprehensive analysis that elucidates the vibrational characteristics of both multilayer powder and delaminated single flakes, with the latter being probed under four distinct excitation wavelengths: 488 nm, 514 nm. 633 nm, and 785 nm (FIG. 3E). For the single-layer flakes, regardless of the excitation wavelength, the consistent presence of the pronounced peak at approximately 600-650 cm⁻¹ is evident. This peak can be associated with the out-of-plane vibrations of carbon, an inherent characteristic of MXene M₃X₂ structures. Compared to the Ti₃C₂Tₓ obtained from the mixed acid etching, this peak has shifted to a lower wavenumber, indicating a softer vibration of the bond affected by Cl surface terminations. Moreover, the sharp peaks in the range of 200 cm⁻¹ to 400 cm⁻¹ indicate in-plane and out-of-plane vibrations of the whole flake and surface terminations, suggesting the material's surface termination is uniform. A noteworthy trend is the varying intensity of the primary ˜170 cm⁻¹ region and ˜600 cm⁻¹ region peaks across the three excitation wavelengths. At 514 nm, the ˜600 cm⁻¹ peak exhibits the most pronounced intensity, progressively diminishing with increasing wavelength to 633 nm and subsequently 785 nm. Meanwhile, the ˜170 cm⁻¹ peak exhibits the least pronounced intensity at 514 nm, progressively enhancing with increasing wavelength to 633 nm and subsequently 785 nm. For the 488 nm laser wavelength, the 170 cm⁻¹ peak is slightly increased, whereas the 600 cm⁻¹ peak is decreased compared to the 514 nm wavelength one. For the Raman shift of multilayer MXene powder excited at 785 nm, the peaks at both ˜170 cm⁻¹ and 600 cm⁻¹ are less pronounced than in their single-layer counterparts. This divergence in behavior could be attributed to the complex interlayer interactions and the charges in the interlayer spacing that were observed in HF-etched Ti₃C₂ with increased thickness.

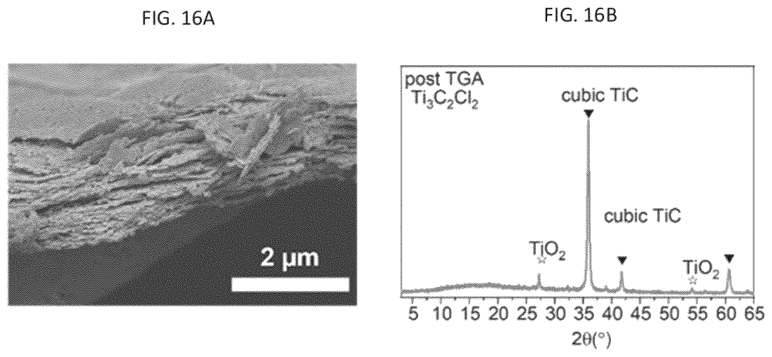

The thermal stability test of Ti₃C₂Cl₂ MXene freestanding film is performed with thermal gravimetric analysis (FIG. 3F). The initial 2.5% weight loss until 400° C. originated from the residual NMF solvent or surface adsorbed water on the sample. As opposed to the HF-etched MXene film, which decomposed at 800° C. LAMS-MXene has the second 5.3% weight loss beginning at 480° C.-620° C., which could be attributed to the loss of Cl termination or formation of vacancies. This process is followed by a 21% weight loss beginning at 929° C. due to the phase transition to cubic titanium carbide (FIGS. 3F and 16). The thermal decomposition temperature is slightly lower than the multilayer Ti₃C₂Cl₂ MXene powder: however, the temperature of the structure collapse is 70° C. higher than the HF-etched MXene film.

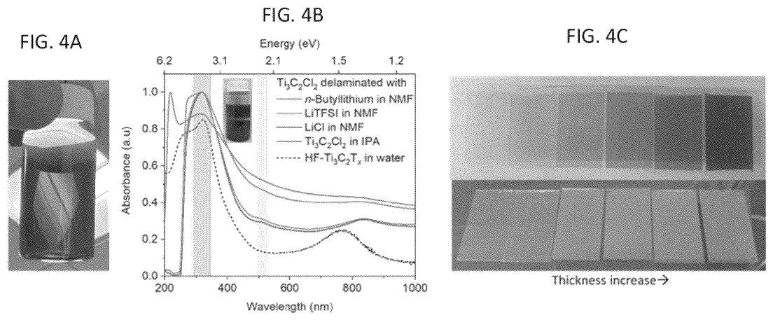

Different from HF-etched Ti₃C₂Tₓ, whose solution typically has a green color, the Ti₃C₂Cl₂ MXene colloidal solution showed a yellowish color regardless of the delamination agent or solvent (FIG. 4A). The UV-Vis spectra of MXene solution with all delamination agents showed the absorbance peak at 840 nm, given a 60 nm red shift compared to HF-etched Ti₃C₂Tₓ because of the different surface terminations. The absorbance peak in the NIR (Near-Infrared Region) of MXene can be assigned to the electronic transitions related to defects, impurities, and functional groups present on the MXene surface. MXenes delaminated using the neutral salts LiCl and LiTFSI have a narrower and more pronounced absorbance peak compared to that of n-butyllithium delaminated MXene, suggesting their improved quality (uniformity). This may be caused by the superbase nature of n-butyllithium, which oxidized the MXene surface and thus broadened the MXene absorbance peak. Regardless of the etching routine, surface chemistry, and solvent. MXene solutions exhibit sharp absorption peaks in the UV (ultraviolet) region at 320 nm, indicating the electronic transitions between the valence and conduction bands of the material. This is related to the metallic properties of MXene: the electronic transition occurs at the Ti—C band and is not affected by surface chemistry. Moreover, there is no absorption peak observed in deep UV—a potentially useful property. Meanwhile, the IPA solution demonstrates a broader absorption peak in this region with a sharp peak at near 200 nm region. The disparity in the shape and intensity of these peaks may suggest differential interactions between the MXene and the solvents, possibly influencing the aggregation state or electronic structure of MXene in these environments and needs further investigation. Also, a new weak absorption peak was observed at 515 nm, which may reveal a different electronic transition mechanism and needs future exploration with other techniques. The existence of a 515 nm absorbance peak corresponds to the excitation of 514 nm wavelength Raman spectra. The lower wavelength region showed a local minimum absorption at 480 nm. This may explain the suppression of A_{1g} peaks of Raman spectra at ˜600 cm⁻¹ for 488 nm wavelength Raman spectra. This change of absorbance peak strongly correlates with the Raman spectra and needs future investigation. In general, the delaminated MXene with well-controlled terminations open opportunities for fundamental studies on MXenes with halogen and other terminations.

The MXene in NMF solution was spray-coated on the glass substrates with different thicknesses (FIG. 4C). As the thickness of a MXene thin film increases, the decrease of film transmittance is observed on a white background, while the increase of reflection is shown with a black background. A metallic blue color was observed for the spray-coated thin film, as opposed to a purple color that is typical for HF-etched MXene. The termination-induced color change of MXene is attributed to the electronic band structure change with Cl termination. The colloidal solution of MXene can be coated on multiple surfaces, making it a good candidate for various practical applications.

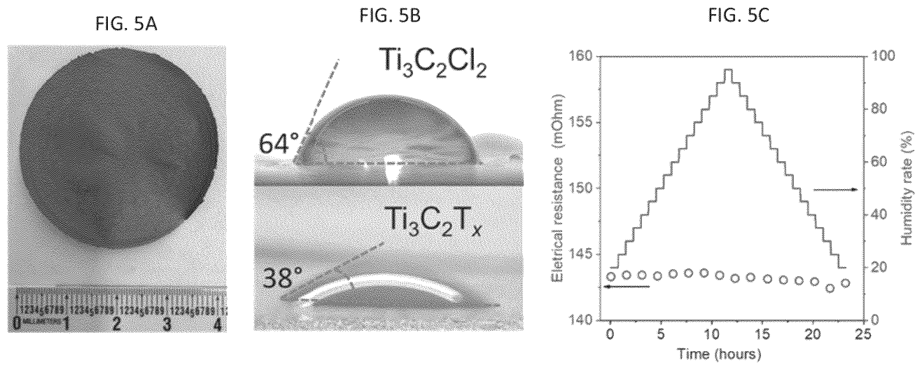

MXene is known for its hydrophilicity, making it easy to coat on multiple surfaces and giving broader applications such as water deciliation, bioelectronics, electronic ink, wearable electronics, and the like. However, the issue of the high hydrophilicity is the swelling effect of MXene film caused the intercalation of water from the ambient, thus the hydrolysis induced the instability under a high humidity environment. A hydrophobic MXene is needed to prevent hydrolysis under high humidity. One effective solution is the functionalization of pristine MXene with a massive chemical reaction process to introduce hydrophobic molecules on the surface of MXene, which greatly increases cost and is not practical for real application. Another solution is protonating MXene with hydrochloric acid to create strong layer-layer interaction in MXene film and prevent the insertion of water molecules. However, this method makes MXene corrosive and non-biocompatible and may degrade the surface it coated. Knowing that multilayer Ti₃C₂Cl₂ MXene is relatively hydrophobic, one would expect its freestanding film to perform similarly. The freestanding film of Ti₃C₂Cl₂ MXene showed a smooth surface in both macroscopic and microscopic views (FIGS. 5A and 2F). The contact angle of water on Ti₃C₂Cl₂ MXene is 64°, whereas on HF-etched Ti₃C₂Tₓ MXene, it is 38°. This is because of the hydrophobic-Cl surface, NMF solvent, and surface microstructure difference in Ti₃C₂Cl₂ MXene compared to HF-etched MXene film (FIG. 2G). To test its humidity stability, we measured the in-situ electrical resistance in the humidity chamber from 20-95 HR %. The humidity stability test of films with an electrical resistance test showed that the conductivity of MXene is not influenced by humidity change, indicating that the water molecules are not intercalated. Also, after storing the film at 95 HR % for 2 weeks, the electrical conductivity of MXene film remained at 7,200 S/cm, which is 90% of its pristine value. Such stable and high conductivity MXene under high humidity environments enables its application under complex environments with a lower risk of degradation.

### CONCLUSIONS

A safe and high-efficiency protocol for delaminating MXenes synthesized using the LAMS method has been developed in this work. We have introduced LiCl in organic solvent as a benign, abundant, inexpensive, and effective delaminating agent. This allowed us to circumvent the challenges traditionally associated with LAMS-MXene delamination, ensuring the preservation of the intrinsic surface chemistry (chlorine terminations) and essential material properties such as high electronic conductivity. XPS revealed the fully preserved halogen terminations after delamination and lack of oxidation. The delaminated MXene solution shows high colloidal stability for at least 3 months. Distinct optical properties of delaminated LAMS-Ti₃C₂Cl₂ are reflected in the Raman and UV-Vis spectra due to the change of termination compared to the HF-etched MXenes. The delaminated MXene can be dispersed in IPA, NMF, DMSO and other polar solvents, spray-coated on a substrate and processed into a flexible freestanding film. The electrical conductivity of the freestanding film was ˜8,000 S/cm, and it was not affected by high humidity. Thermogravimetric analysis showed higher thermal stability compared to the HF-etched Ti₃C₂Tₓ. A universal strategy for delamination of LAMS-MXene in various polar aprotic solvents has been developed.

### EXPERIMENTAL

Synthesis of MAX phase. MAX phase was synthesized. The powder of TiC (Alfa Aesar, 99.5%, 2 μm powder), Ti (Alfa Aesar, 99.5%, 325 mesh) and Al (Alfa Aesar, 99.5%, 325 mesh) were mixed in a molar ratio of 2:1.5:2.2 and mixed with zirconia ball (2:1 mass ratio of precursor powder) for 18 hours at speed of 70 rpm in a HDPE bottle followed by passivation for 6 hours. The mixed powders were transferred into the alumina crucible and followed by annealing in a high-temperature tube furnace (MTI). The tube was constantly flowing with ultra-high purity Ar at 200 SCCM. The furnace was heated (and cooled) at 3° C./min to 1380° C. and held for 2 h. The sintered block was then crushed into small pieces and stirred with concentrated HCl (Fisher Scientific, 38 wt. %) for 48 hours to dissolve away the excess aluminum and intermetallic impurities. Then, the acid-washed MAX phase was washed with deionized water by vacuum-assisted filtration (polycarbonate, pore size <5 μm) until neutral. The MAX phase powder was dried overnight in a vacuum furnace at 80° C. and sieved under 38 μm for future etching.

LAMS Synthesis of MXene. The LAMS synthesis of MXene was modified from the previously reported method.^{13,16,24} A schematic of MXene synthesized by molten salt is shown in FIG. 1A. For the synthesis of Ti₃C₂Cl₂ MXene, ZnCl₂ (Sigma Aldrich, >99%, anhydrous) was chosen as the Lewis acid. It is hygroscopic and needs to be stored in an Ar or N₂-filled environment. Therefore, mixing with MAX was performed in the Ar-filled glovebox. First, ZnCl₂ was milled into fine powder in a mortar for 10 minutes. Then 10 g of Ti₃AlC₂ MAX phase and 80 g of fine ZnCl₂ were added into a 250 mL glass bottle and shaken for 2 minutes for mixing. After mixing the powders, the mix was transferred into an alumina crucible. The filled crucible was then placed in a Ziplock bag under Argon and transferred out from the glovebox to isolate it from the moisture and then transferred to a tube furnace (MTI) and heated to 640° C. at 5° C. min-1 under constant Argon flow (99%, 5 SCCM). The reaction was conducted over 4 hours, after which the furnace was cooled at the same rate.

To wash the unreacted ZnCl₂ and Zn byproduct, the reacted MS-MXene was transferred out from the tube and added into 200 mL of 12M HCl in a 500 mL glass bottle. The solution was stirred at 300 rpm for 6 hours at room temperature to remove the Zn particle completely. The acid-washed MS-MXene was then transferred into two 125 mL centrifuge vials and filled with DI water, washed with a centrifuge at 1,500 rcf for 5 minutes, and repeated 3 times. Small MXene flakes pose a problem during filtration because they block the pores of the filter membrane and slow down the filtration process significantly. This step allows the removal of small flakes of MXene beforehand to facilitate the following filtering process. After the centrifuge wash, the multilayer MXene in sediment was redispersed into DI water and filtered by a 5 μm Polycarbonate membrane. After the water was dried, more DI water was added. The total amount of DI water for filtering was around 2 L. After the filter, the wet powder was dried in ambient air for one hour. Then, the powders were transferred into a glass vial and further dried under vacuum at 45° C. for 48 hours. The completely dried MXene powders were transferred into the glovebox for future use.

Synthesis of HF—Ti₃C₂. The HF etched Li-Ti₃C₂Tₓ were synthesized via the previously reported method.³⁵

Characterization. X-ray diffraction (XRD) measurements were conducted on the MXene powders and freestanding film using a Rigaku SmartLab (Tokyo, Japan) diffractometer operating at 40 kV and 30 mA with a Cu Kα X-ray source. The scan range was from 3-80° (2θ), with a step-scan of 0.02° for 0.6 s holding time. Reflection-mode Raman spectra were collected using a Renishaw InVia Raman microscope (Gloucestershire, UK) spectrometer using ×63 objective and 1800 line/mm grating with 488, 514, 633, and 785 nm laser wavelengths. The MXene flakes and powders were deposited on a gold-coated glass substrate. Scanning electron microscopy (SEM) analysis was performed using a Zeiss Supra 50VP microscope with a 3 kV beam, 5 mm working distance, and in-lens detector. XPS spectra were collected on a PHI VersaProbe 5000 instrument (Physical Electronics, U.S.) spectrometer using a 200 μm and 50 W monochromatic Al Kα X-ray source (1486.6 eV) and a 23.5 eV pass energy with a step size of 0.05 eV. MXene freestanding film is loaded on conductive carbon tapes without sputtering. Peak fitting of high-resolution XPS spectra was performed with CasaXPS V2.3.25 software. A Tougaard background was used for transition metal-based compounds. An In-situ resistance-humidity test was performed using the Memmert HCP50 humidity chamber and a four-point probe connected with the Keithley 2400) Sourcemeter. The Humidity chamber was set a 20%-95%-20% humidity rate with a step size of 5 HR % at 35° C. Each humidity is held for 45 minutes for stabilizing humidity. The resistance was recorded with Keithly Kickstart software.

In the main text, we explored multiple delamination methodologies for LMAS-MXene. This section presents a flowchart diagram (FIG. 7) illustrating these routines, accompanied by discussions on potential mechanisms underlying the delamination process.

Initially, LMAS-MXene layers treated with LiCl/DMSO underwent centrifugation to remove excess DMSO and LiCl, yielding Li+ intercalated multilayers (Step 1). This process resulted in a d-spacing expansion of 0.22 Å, as evidenced by the broadening of the 002 peaks in X-ray diffraction (XRD) patterns (FIG. 9). Subsequently, we attempted delamination using a combination of tetrahydrofuran (THF) and N, N-methylformamide (NMF) washes (Step 2d). Interestingly, MXene swelling was not observed even after three THF washes. XRD analysis revealed a d-spacing reduction to 11.10 Å and a sharper 002 peak compared to the LiCl intercalated sample, suggesting the removal or rearrangement of intercalated Li cations.

Contrastingly, significant MXene swelling occurred following NMF washes in Step 2d. Continuous NMF washing led to substantial volume expansion (approximately fivefold), resulting in NMF-swelled MXene with a d-spacing of 11.34 Å, which is greater than post-LiCl intercalation. Further NMF washing facilitated successful, high-yield delamination (Step 3a).

We also investigated multiple alternative routines for preliminary insights into the delamination process. In Step 2a, Li intercalated LMAS-MXene was washed repeatedly with various polar aprotic solvents, including NMF, DMSO, DMF, NMP, and PC, without observing swelling or delamination. This outcome underscores the role of THF (dielectric constant=7.58) in facilitating MXene swelling. Comparatively, routines involving THF followed by DMSO, DMF, NMP, or PC (Step 2b) did not induce swelling or delamination, highlighting the unique role of NMF, which possesses an extraordinarily high dielectric constant (˜182), unlike other tested solvents with lower dielectric constants (below 50).

Considering the influence of the dielectric constant on delamination and

THF's low dielectric constant, we hypothesized that the substantial disparity in polarity and dielectric constant between two solvents (low followed by high) might contribute to delamination. To test this, we replaced THF with toluene (dielectric constant=2.38) in Step 2c. Similar to the THF-NMF routine, we observed volume expansion in the LAMS-MXene following toluene and subsequent NMF washes. The d-spacing expansion in this Toluene-NMF routine was even larger than in the THF-NMF routine, achieving a d-spacing of 12 Å. Continued washing with NMF led to the successful delamination of NMF-swelled MXene in various solvents (Step 3b, FIG. 7), albeit with a lower yield than the THF-NMF routine, indicating that additional NMF washes might be necessary for complete swelling and delamination.

These preliminary studies suggest that solvent polarity plays a significant role in the delamination process. Other solvents with low dielectric constants, such as Diethylamine (DA) or Chloroform, can be useful as initial washing solvents, and formamide can be useful as the swelling solvent.
1. Naguib, M.; Kurtoglu, M.; Presser, V.; Lu, J.; Niu, J.; Heon, M.; Hultman, L.; Gogotsi, Y.; Barsoum, M. W. Two-Dimensional Nanocrystals Produced by Exfoliation of Ti3AlC2. Adv. Mater. 2011, 23 (37), 4248-4253.
2. Li, X.; Huang, Z.; Shuck, C. E.; Liang, G.; Gogotsi, Y.; Zhi, C. MXene Chemistry, Electrochemistry and Energy Storage Applications. Nat. Rev. Chem. 2022, 0123456789.
3. Anasori, B.; Gogotsi, Y. MXenes: Trends, Growth, and Future Directions. Graphene and 2D Materials 2022, 7 (3-4), 75-79.
4. Gogotsi, Y.; Anasori, B. The Rise of MXenes. ACS Nano 2019, 13 (8), 8491-8494.
5. Lim, K. R. G.: Shekhirev, M.; Wyatt, B. C.: Anasori, B.; Gogotsi, Y.; Seh, Z. W. Fundamentals of MXene Synthesis. Nat. Synthesis. 2022, 1 (8), 601-614.
6. Vahid Mohammadi, A., Rosen, J. & Gogotsi, Y. The world of two-dimensional carbides and nitrides (MXenes). Science 372, eabf1581 (2021).
7. Natu, V.; Barsoum, M. W. MXene Surface Terminations: A Perspective. J. Phys. Chem. C 2023, 127 (41), 20197-20206.
8. Anayee, M.; Shuck, C. E.; Shekhirev, M.; Goad, A.; Wang, R.; Gogotsi, Y. Kinetics of Ti3 AlC2 Etching for Ti3C2T x MXene Synthesis. Chem. Mater. 2022, 34 (21), 9589-9600.
9. Griffith, K. J.: Hope, M. A.; Reeves, P. J.: Anayee, M.; Gogotsi, Y.; Grey, C. P. Bulk and Surface Chemistry of the Niobium MAX and MXene Phases from Multinuclear Solid-State NMR Spectroscopy. J. Am. Chem. Soc. 2020, 142 (44), 18924-18935.
10. Mashtalir, O.; Naguib, M.; Mochalin, V. N.; Dall'Agnese, Y.; Heon, M.; Barsoum, M. W.: Gogotsi, Y. Intercalation and Delamination of Layered Carbides and Carbonitrides. Nat. Commun. 2013, 4 (1), 1716.
11. Alhabeb, M.; Maleski, K.; Anasori, B.; Lelyukh, P.; Clark, L.; Sin, S.; Gogotsi, Y. Guidelines for Synthesis and Processing of Two-Dimensional Titanium Carbide (Ti3C2Tx MXene). Chem. Mater. 2017, 29 (18), 7633-7644.
12. Hart, J. L.; Hantanasirisakul, K.; Lang, A. C.; Anasori, B.; Pinto, D.; Pivak, Y.; van Omme, J. T.: May, S. J.: Gogotsi, Y.; Taheri, M. L. Control of MXenes' Electronic Properties through Termination and Intercalation. Nat. Commun. 2019, 10 (1), 522.
13. Kamysbayev, V.; Filatov, A. S.; Hu, H.; Rui, X.; Lagunas, F.; Wang, D.; Klie, R. F.; Talapin, D. V. Covalent Surface Modifications and Superconductivity of Two-Dimensional Metal Carbide MXenes. Science 2020, 369 (6506), 979-983.
14. Li, Y.; Shao, H.; Lin, Z.; Lu, J.; Liu, L.; Duployer, B.; Persson, P. O. A.; Eklund, P.; Hultman, L.; Li, M.; Chen, K.; Zha, X.-H.; Du, S.; Rozier, P.; Chai, Z.: Raymundo-Piñero, E.: Taberna, P.-L.: Simon, P.; Huang, Q. A General Lewis Acidic Etching Route for Preparing MXenes with Enhanced Electrochemical Performance in Non-Aqueous Electrolyte. Nat. Mater. 2020, 19 (8), 894-899.
15. Li, M.: Li, X.; Qin, G.; Luo, K.; Lu, J.; Li, Y.: Liang, G.: Huang, Z.: Zhou, J.: Hultman, L.; Eklund, P.: Persson, P. O. Å.: Du, S.; Chai, Z.: Zhi, C.: Huang, Q. Halogenated Ti3C2 MXenes with Electrochemically Active Terminals for High-Performance Zinc Ion Batteries. ACS Nano 2021, 15 (1), 1077-1085.
16. Ding, H.: Li, Y.: Li, M.: Chen, K.: Liang, K.; Chen, G.; Lu, J.: Palisaitis, J.: Persson, O. Å.; Hultman, L.: Du, S.; Chai, Z.: Gogotsi, Y.; Huang, Q. Chemical Scissor-Mediated Structural Editing of Layered Transition Metal Carbides. Science 2023, 379(6637), 1130-1135
17. Wang, D.: Zhou, C.: Filatov, A. S.: Cho, W.; Lagunas, F.: Wang, M.; Vaikuntanathan, S.; Liu, C.; Klie, R. F.: Talapin, D. V. Direct Synthesis and Chemical Vapor Deposition of 2D Carbide and Nitride MXenes. Science 2023, 379 (6638), 1242-1247.
18. Zhou, C.: Wang, D.; Lagunas, F.; Atterberry, B.; Lei, M.: Hu, H.; Zhou, Z.: Filatov, A. S.; Jiang, D. en; Rossini, A. J.: Klie, R. F.; Talapin, D. V. Hybrid Organic-Inorganic Two-Dimensional Metal Carbide MXenes with Amido- and Imido-Terminated Surfaces. Nat. Chem. 2023, 15(12), 1722-1729.
19. Liu, L.: Orbay, M.: Luo, S.: Duluard, S.: Shao, H.: Harmel, J.: Rozier, P.: Taberna, P.-L.: Simon, P. Exfoliation and Delamination of Ti3C2Tx MXene Prepared via Molten Salt Etching Route. ACS Nano 2022, 16 (1), 111-118.
20. Arole, K.: Blivin, J. W.: Bruce, A. M.: Athavale, S.: Echols, I. J.: Cao, H.: Tan, Z.: Radovic, M.; Lutkenhaus, J. L.: Green, M. J. Exfoliation, Delamination, and Oxidation Stability of Molten Salt Etched Nb2CTz MXene Nanosheets. Chem. Commun. 2022, 58 (73), 10202-10205.
21. Arole, K.; Blivin, J. W.: Saha, S.: Holta, D. E.: Zhao, X.: Sarmah, A.: Cao, H.: Radovic, M.: Lutkenhaus, J. L.: Green, M. J. Water-Dispersible Ti3C2Tz MXene Nanosheets by Molten Salt Etching. iScience 2021, 24 (12).
22. Wang, X.: Shi, Y.: Qiu, J.: Wang, Z. Molten-Salt Etching Synthesis of Delaminatable MXenes. Chem. Commun. 2023, 59 (34), 5063-5066.
23. Shekhirev, M.: Shuck, C. E.: Sarycheva, A.: Gogotsi, Y. Characterization of MXenes at Every Step, from Their Precursors to Single Flakes and Assembled Films. Prog. Mater. Sci. 2021, 120, 100757.
24. Li, M.: Lu, J.: Luo, K.: Li, Y.: Chang, K.: Chen, K.: Zhou, J.: Rosen, J.: Hultman, L.; Eklund, P.: O. Å. Persson, P.: Du, S.: Chai, Z.: Huang, Z.: Huang, Q. Element Replacement Approach by Reaction with Lewis Acidic Molten Salts to Synthesize Nanolaminated MAX Phases and MXenes. J. Am. Chem. Soc. 2019, 141 (11), 4730-4737.
25. Célérier, S.: Hurand, S.: Garnero, C.: Morisset, S.: Benchakar, M.: Habrioux, A.: Chartier, P.: Mauchamp, V.: Findling, N.: Lanson, B.: Ferrage, E. Hydration of Ti3C2T x MXene: An Interstratification Process with Major Implications on Physical Properties. Chem. Mater. 2019, 31 (2), 454-461.
26. Wang, X.: Mathis, T. S.: Li, K.: Lin, Z.: Vlcek, L.: Torita, T.: Osti, N. C.: Hatter, C.: Urbankowski, P.: Sarycheva, A.: Tyagi, M.: Mamontov, E.: Simon, P.: Gogotsi, Y. Influences from Solvents on Charge Storage in Titanium Carbide MXenes. Nat. Energy. 2019, 4 (3), 241-248.
27. Michałowski, P. P.: Anayee, M.: Mathis, T. S.: Kozdra, S.: Wójcik, A.: Hantanasirisakul, K.: Jóźwik, I.: Piątkowska, A.: Możdżonek, M.: Malinowska, A.: Diduszko, R.: Wierzbicka, E.: Gogotsi, Y. Oxycarbide MXenes and MAX Phases Identification Using Monoatomic Layer-by-Layer Analysis with Ultralow-Energy Secondary-Ion Mass Spectrometry. Nat. Nanotechnol. 2022, 17 (11), 1192-1197.
28. Shevchuk, K.: Sarycheva, A.: Shuck, C. E.: Gogotsi, Y. Raman Spectroscopy Characterization of 2D Carbide and Carbonitride MXenes. Chem. Mater. 2023, 35 (19), 8239-8247.
29. Sarycheva, A.: Gogotsi, Y. Raman Spectroscopy Analysis of the Structure and Surface Chemistry of Ti3C2Tx MXene. Chem. Mater. 2020, 32 (8), 3480-3488.
30. Hu, T.: Wang, J.: Zhang, H.: Li, Z.: Hu, M.: Wang, X. Vibrational Properties of Ti3C2 and Ti3C2T2 (T=O, F, OH) Monosheets by First-Principles Calculations: A Comparative Study. Phys. Chem. Chem. Phys. 2015, 17 (15), 9997-10003.
31. Berger, E.: Lv, Z.-P.: Komsa, H.-P. Raman Spectra of 2D Titanium Carbide MXene from Machine-Learning Force Field Molecular Dynamics. J. Mater. Chem. C Mater. 2023, 11 (4), 1311-1319.
32. Gouadec, G.: Colomban, P. Raman Spectroscopy of Nanomaterials: How Spectra Relate to Disorder, Particle Size and Mechanical Properties. Prog. Cryst. Growth Charact. Mater. 2007, 53 (1), 1-56.
33. Seredych, M.: Shuck, C. E.: Pinto, D.: Alhabeb, M.: Precetti, E.: Deysher, G.: Anasori, B.: Kurra, N.: Gogotsi, Y. High-Temperature Behavior and Surface Chemistry of Carbide MXenes Studied by Thermal Analysis. Chem. Mater. 2019, 31 (9), 3324-3332.
34. Zhang, T.: Shuck, C. E.: Shevchuk, K.: Anayee, M.: Gogotsi, Y. Synthesis of Three Families of Titanium Carbonitride MXenes. J. Am. Chem. Soc. 2023, 145 (41), 22374-22383.
35. Mathis, T. S.: Maleski, K.; Goad, A.: Sarycheva, A.: Anayee, M.: Foucher, A. C.: Hantanasirisakul, K.: Shuck, C. E.: Stach, E. A.: Gogotsi, Y. Modified MAX Phase Synthesis for Environmentally Stable and Highly Conductive Ti3C2 MXene. ACS Nano 2021, 15 (4), 6420-6429.
36. Hantanasirisakul, K.: Alhabeb, M.: Lipatov, A.: Maleski, K.: Anasori, B.: Salles, P.: Ieosakulrat, C.: Pakawatpanurut, P.: Sinitskii, A.: May, S. J.: Gogotsi, Y. Effects of Synthesis and Processing on Optoelectronic Properties of Titanium Carbonitride MXene. Chem. Mater. 2019, 31 (8), 2941-2951.
37. Hantanasirisakul, K.: Gogotsi, Y. Electronic and Optical Properties of 2D Transition Metal Carbides and Nitrides (MXenes). Adv. Mater. 2018, 30(52): e1804779
38. Gogotsi, Y.: Huang, Q. MXenes: Two-Dimensional Building Blocks for Future Materials and Devices. ACS Nano 2021, 15 (4), 5775-5780.
39. Azadi, S. K.: Zeynali, M.: Asgharizadeh, S.: Fooladloo, M. A. Investigation of the Optical and Electronic Properties of Functionalized Ti3C2 Mxene with Halid Atoms Using DFT Calculation. Mater. Today. Commun. 2023, 35, 106136.
40. Shahzad, F.: Alhabeb, M.: Hatter, C. B.: Anasori, B.: Hong, S. M.: Koo, C. M.: Gogotsi, Y. Electromagnetic Interference Shielding with 2D Transition Metal Carbides (MXenes). Science 2016, 353 (6304), 1137-1140.
41. Simon, P.: Gogotsi, Y. Perspectives for Electrochemical Capacitors and Related Devices. Nat. Mater. 2020, 19 (11), 1151-1163.
42. Cai, Y.: Shen, J.: Yang, C. W.: Wan, Y.: Tang, H. L.: Aljarb, A. A.: Chen, C.: Fu, J. H.: Wei, X.: Huang, K. W.: Han, Y.: Jonas, S. J.: Dong, X.: Tung, V. Mixed-Dimensional MXene-Hydrogel Heterostructures for Electronic Skin Sensors with Ultrabroad Working Range. Sci. Adv. 2020, 6 (48)
43. Zaman, W.: Matsumoto, R. A.: Thompson, M. W.: Liu, Y.-H.: Bootwala, Y.: Dixit, M. B.: Nemsak, S.: Crumlin, E.: Hatzell, M. C.: Cummings, P. T.: Hatzell, K. B. In Situ Investigation of Water on MXene Interfaces. Proc. Natl. Acad. Sci. U.S.A. 2021, 118 (49), 1-9.
(1) Doo, S.: Chae, A.: Kim, D.: Oh, T.: Ko, T. Y.: Kim, S. J.: Koh, D.-Y.: Koo, C. M. Mechanism and Kinetics of Oxidation Reaction of Aqueous Ti3C2T x Suspensions at Different PHs and Temperatures. ACS Appl Mater Interfaces 2021, 13 (19), 22855-22865.
(2) Ding, H.: Li, Y.: Li, M.: Chen, K.: Liang, K.: Chen, G.: Lu, J.: Palisaitis, J.: Persson, O. Å.: Hultman, L.: Du, S.: Chai, Z.: Gogotsi, Y.: Huang, Q. Chemical Scissor-Mediated Structural Editing of Layered Transition Metal Carbides: Science, 2023, 379, 1130-1135.
(3) Zhang, T.: Shuck, C. E.: Shevchuk, K.: Anayee, M.: Gogotsi, Y. Synthesis of Three Families of Titanium Carbonitride MXenes. J Am Chem Soc 2023, 145 (41), 22374-22383.
(4) Halim, J.: Cook, K. M.: Naguib, M.: Eklund, P.: Gogotsi, Y.: Rosen, J.: Barsoum, M. W. X-Ray Photoelectron Spectroscopy of Select Multi-Layered Transition Metal Carbides (MXenes). Appl Surf Sci 2016, 362, 406-417.
(5) Shekhirev, M.; Shuck, C. E.; Sarycheva, A.; Gogotsi, Y. Characterization of MXenes at Every Step, from Their Precursors to Single Flakes and Assembled Films. Prog Mater Sci 2021, 120, 100757.

TABLE 1
Comparison of d-spacing calculated from (002) peak and
(004) peaks for LAMS-Ti₃C₂Cl₂ MXene as the pristine multilayer
powder, LiCl intercalated multilayer powder, LiCl delaminated
film and N-Butyllithium delaminated film.

d-spacing (Å)

| | (from | from |
|---|---|---|
| | (002) | (004) |
| LAMS-Ti₃C₂Cl₂ MXene | peak | peak |
| multilayer powder | 11.08 | 11.08 |
| LiCl intercalated multilayer | 11.30 | 11.14 |
| powder | | |
| LiCl delaminated film | 11.38 | 11.15 |
| N-Butyllithium delaminated | 12.00 | 11.36 |
| film | | |

### ASPECTS

The following Aspects are illustrative only and do not limit the scope of the present disclosure or the appended claims. Any part or parts of any one or more Aspects can be combined with any part or parts of any one or more other Aspects.

Aspect 1. A method, comprising: contacting (i) a multilayered MXene comprising any one or more of halogen terminations, chalcogen terminations, or organic terminations with (ii) cations dissolved in a non-aqueous solvent, the contacting being performed so as to give rise to a cation-intercalated MXene; and delaminating the cation-intercalated MXene.

Aspect 2. The method of Aspect 1, wherein the delaminating comprises any one or more of swelling the cation-intercalated MXene or sonicating the cation-intercalated MXene.

Aspect 3. The method of Aspect 1, wherein the cations comprise metal cations.

Aspect 4. The method of Aspect 3, wherein the metal cations comprise any one or more of Li, Na, or K.

Aspect 5. The method of Aspect 1, wherein the cations comprise anhydrous cations.

Aspect 6. The method of Aspect 5, wherein the wherein the anhydrous cations comprise metal cations.

Aspect 7. The method of Aspect 6, wherein the metal cations comprise any one or more of Li, Na or K.

Aspect 8. The method of Aspect 5, wherein the anhydrous cations comprise quaternary ammonium cations. Such cations can include, for example, tetrabutylammonium, tetramethylammonium or cetrimonium (hexadecyltrimethylammonium) cations.

Aspect 8. The method of any one of Aspects 1-8, wherein the non-aqueous solvent comprises any one or more of dimethyl sulfoxide (DMSO) or propylene carbonate (PC).

Aspect 9. The method of any one of Aspects 1-9, wherein the delaminating comprises removing excess cations from the cation-intercalated MXene, optionally wherein the removing is effected by a removal solvent, the removal solvent optionally comprising any one or more of tetrahydrofuran (THF), N-methylformamide (NMF), toluene, hexane, or chloroform.

Aspect 10. The method of any one of Aspects 1-10, wherein the delaminating comprises swelling the cation-intercalated MXene, the swelling optionally being effected by a swelling solvent.

Aspect 12. The method of Aspect 11, wherein the swelling solvent comprises NMF.

Aspect 13. The method of Aspect 11, further comprising exchanging the swelling solvent for a delamination solvent.

Aspect 14. The method of Aspect 13, wherein the delamination solvent is any one or more of acetonitrile, DMSO, DMF, DMF, isopropyl alcohol, NMP, and propylene carbonate.

Aspect 15. The method of any one of Aspects 1-14, wherein the delaminating comprises any one or more of sonication, shaking, and centrifugation.

Aspect 16. The method of any one of Aspects 1-15, wherein the cations are derived from dissolving a salt in the non-aqueous solvent.

Aspect 17. The method of any one of Aspects 1-16, wherein delaminating the cation-intercalated MXene gives rise to an MXene product comprising an MXene layer having a uniform termination. Such terminations can be of one type of either halogen or chalcogen element. In some embodiments, the terminations can comprise chalcogen and halogen elements.

Aspect 18. A MXene layer, the MXene layer comprising uniform or essentially uniform terminations.

Aspect 19. The MXene layer of Aspect 18, wherein the terminations comprise any one or more of halogen terminations, chalcogen terminations, or organic terminations.

Aspect 20. The MXene layer of Aspect 19, wherein the terminations comprise halogen terminations. Suitable such halogens include, for example, F, Cl, or Br.

Aspect 21. The MXene layer of Aspect 19, wherein the terminations comprise chalcogen terminations. Suitable such terminations include, for example, S, Te, or Se.

Aspect 22. The MXene layer of Aspect 19, wherein the terminations comprise organic terminations. Such terminations can include, for example, amido- and imido-groups.

Aspect 23. A film, the film comprising a MXene layer according to any one of Aspects 18-22.

Aspect 24. The film of Aspect 23, wherein the film is a freestanding film.

Aspect 25. A method, comprising: delaminating a cation-intercalated MXene comprising any one or more of halogen terminations, chalcogen terminations, or organic terminations so as to give rise to a MXene layer comprising uniform or essentially uniform terminations.

Aspect 26. A method, comprising: intercalating a cation into a multilayered MXene comprising any one or more of halogen terminations, chalcogen terminations, or organic terminations so as to give rise to a cation-intercalated MXene: swelling the cation-intercalated MXene; and delaminating the cation-intercalated MXene so as to give rise to a MXene layer comprising uniform or essentially uniform terminations.

What is claimed:

1. A method, comprising:
contacting (i) a multilayered MXene comprising any one or more of halogen terminations, chalcogen terminations, or organic terminations with (ii) cations dissolved in a non-aqueous solvent,
the contacting being performed so as to give rise to a cation-intercalated MXene; and
delaminating the cation-intercalated MXene.

2. The method of claim 1, wherein the delaminating comprises any one or more of swelling the cation-intercalated MXene or sonicating the cation-intercalated MXene.

3. The method of claim 1, wherein the cations comprise metal cations.

4. The method of claim 3, wherein the metal cations comprise any one or more of Li or Na or K.

5. The method of claim 1, wherein the cations comprise anhydrous cations.

6. The method of claim 5, wherein the wherein the anhydrous cations comprise metal cations.

7. The method of claim 6, wherein the metal cations comprise any one or more of Li, Na or K.

8. The method of claim 5, wherein the anhydrous cations comprise quaternary ammonium cations such as tetrabutylammonium, tetramethylammonium or cetrimonium (hexadecyltrimethylammonium) cations.

9. The method of claim 1, wherein the non-aqueous solvent comprises any one or more of dimethyl sulfoxide (DMSO) or propylene carbonate (PC).

10. The method of claim 1, wherein the delaminating comprises removing excess cations from the cation-intercalated MXene, optionally wherein the removing is effected by a removal solvent, the removal solvent optionally comprising any one or more of tetrahydrofuran (THF), N-methylformamide (NMF), toluene, hexane, or chloroform.

11. The method of claim 1, wherein the delaminating comprises swelling the cation-intercalated MXene, the swelling optionally being effected by a swelling solvent.

12. The method of claim 11, wherein the swelling solvent comprises NMF.

13. The method of claim 11, further comprising exchanging the swelling solvent for a delamination solvent.

14. The method of claim 13, wherein the delamination solvent is any one or more of acetonitrile, DMSO, DMF, DMF, isopropyl alcohol, NMP, and propylene carbonate.

15. The method of claim 1, wherein the delaminating comprises any one or more of sonication, shaking, and centrifugation.

16. The method of claim 1, wherein delaminating the cation-intercalated MXene gives rise to an MXene product comprising an MXene layer having a uniform termination.

17. A MXene layer, the MXene layer comprising uniform or essentially uniform terminations, the terminations optionally comprising any one or more of halogen terminations, chalcogen terminations, or organic terminations.

18. A film, the film comprising a MXene layer according to claim 17, the film optionally being a freestanding film.

19. A method, comprising:
delaminating a cation-intercalated MXene comprising any one or more of halogen terminations, chalcogen terminations, or organic terminations so as to give rise to a MXene layer comprising uniform or essentially uniform terminations.

20. A method, comprising:
intercalating a cation into a multilayered MXene comprising any one or more of halogen terminations, chalcogen terminations, or organic terminations so as to give rise to a cation-intercalated MXene;
swelling the cation-intercalated MXene; and
delaminating the cation-intercalated MXene so as to give rise to a MXene layer comprising uniform or essentially uniform terminations.
